(19) United States
(12) Patent Application Publication
(10) Pub. No.: US 2004/0165201 A1
(43) Pub. Date: Aug. 26, 2004

(54) Method and apparatus for forming color image

(75) Inventor: Yoon-seop Eom, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/750,839

(22) Filed: Jan. 5, 2004

(30) Foreign Application Priority Data
Feb. 20, 2003 (KR) 2003-10725

(51) Int. Cl. H04N 1/60

(52) U.S. Cl. 358/1.9; 358/3.24; 358/518

(57) ABSTRACT

A color image forming method of a color image forming apparatus that is connected to a host computer and which receives image forming data generated in the host computer. The color image forming apparatus includes: generating first image data image-processed into a format suitable for use in a color image forming engine by a first image processor disposed within the color image forming apparatus; generating second image data image-processed into a format suitable for use in the color image forming engine by a second image processor disposed outside the color image forming apparatus; and receiving at least one of the first and second image data and selectively outputting the at least one of the first and second image data to the color image forming engine via an image data controller disposed within the color image forming apparatus.

### CROSS-REFERENCE TO RELATED APPLICATIONS

This application claims the priority of Korean Patent Application No. 2003-10725, filed on Feb. 20, 2003, in the Korean Intellectual Property Office, the disclosure of which is incorporated herein in its entirety by reference.

### BACKGROUND OF THE INVENTION

1. Field of the Invention

The present invention relates to a method and apparatus for forming a color image, and more particularly, to a color image forming method and apparatus for forming an image by selecting data received from a first image processor disposed in the color image forming apparatus and a second image processor externally attached thereto.

2. Description of the Related Art

A color image forming apparatus such as a color laser printer prints a color document prepared in a host computer. One example of a color image forming apparatus and method is disclosed in U.S. application Ser. No. 09/770,236.

FIG. 1 is a block diagram of a conventional color image forming apparatus and a host computer. Referring to FIG. 1, a typical color image forming apparatus 10 includes an image processing unit 30 and a color image forming engine 40. The color image forming engine 40 consists of an engine controller 50 and an engine mechatronics unit 42. As used herein, the term mechatronics refers to the interdisciplinary fusion of mechanics, electronics and information technology.

FIG. 2 is a block diagram of the image processing unit 30 and the engine controller 50 shown in FIG. 1. Typically, the image processing unit 30 and the engine controller 50 are constructed on separate boards. The image processing unit 30 includes a microprocessor 32, a ROM 36, a RAM 35, an EEPROM 37, an engine interface unit 34, a communication interface unit 39, and an I/O unit 38. The engine controller 50 is comprised of a microprocessor 52, a ROM 56, a RAM 55, an EEPROM 57, an engine interface unit 54, and an I/O unit 58. While the engine interface units 34 and 54 of the image processing unit 30 and the engine controller 50 function as an engine interface, the communication interface unit 39 of the image processing unit 30 serves as a communication interface with a host computer 20.

In operation, the host computer 20 or a similar data processing device transmits data for forming an image to the color image forming apparatus 10 through a communication interface. Then, the image processing unit 30 of the color image forming apparatus 10 processes the data received from the host computer 20 into a format suitable for image forming. The image data thus processed by the image processing unit 30 is transmitted to the engine controller 50 of the color image forming engine 40, which drives the engine mechatronics unit 42 to perform an image forming process.

The processing speed and image quality of a conventional color image forming apparatus depend on the performance of a color image forming engine. That is, the maximum processing speed and image quality are limited by the performance of the color image forming engine. Generally, the processing speed and image quality of the color image forming apparatus depends on an image processing unit in the color image forming apparatus.

However, the image processing unit incorporated into the conventional color image forming apparatus cannot be upgraded. Thus, a low-level color image forming apparatus cannot be upgraded to a high-level type. Another drawback is that since the conventional color forming apparatus has a single image processing unit, the color image forming engine cannot be effectively used even when it has high performance.

### SUMMARY OF THE INVENTION

The present invention provides a color image forming method capable of forming an image by selecting data received from a first image processor housed within a color image forming apparatus and a second image processor installed outside the color image forming apparatus.

The present invention also provides a color image forming apparatus using the above color image forming method.

Additional and/or other aspects and advantages of the invention will be set forth in part in the description which follows and, in part, will be obvious from the description, or may be learned by practice of the invention.

According to an aspect of the present invention, there is provided a color image forming method of a color image forming apparatus that is connected to a host computer and which receives image forming data generated in the host computer, comprising: generating first image data image-processed into a format suitable for use in a color image forming engine by a first image processor disposed within the color image forming apparatus; generating second image data image-processed into a format suitable for use in the color image forming engine by a second image processor disposed outside the color image forming apparatus; and receiving at least one of the first and second image data and selectively outputting the at least one of the first and second image data to the color image forming engine via an image data controller disposed within the color image forming apparatus.

According to another aspect of the present invention, there is provided a color image forming apparatus connected to a host computer to receive image forming data generated in the host computer, including: a first image data generator disposed within a first image processor disposed in the color image forming apparatus which generates first image data image-processed into a format suitable for use in a color image forming engine; a second image data generator disposed in a second image processor disposed outside of the color image forming apparatus which generates second image data image-processed into a format suitable for use in the color image forming engine; and an image data controller disposed within the color image forming apparatus and which receives at least one of the first and second image data and which selectively outputs the at least one of first and second image data to the color image forming engine.

The second image processor may be a system expansion card which is insertable into the host computer or may be externally attached to the host computer.

The first image processor may be slower than the second image processor. The first image processor may operate according to a graphic device interface (GDI) format.

The second image processor may operate according to a page description language (PDL) format.

The first and second image processors may generate image data suitable for a single path mode or a multi-path mode. The image data controller may be located within the first image processor.

According to still another aspect of the present invention, there is provided a color image forming system including: a color image forming apparatus having therein a first data image generator which generates first image data; a second image generator which generates second image data and is external to the color image forming apparatus; an image data controller which receives the first and the second image data, selectively outputs the first and the second image data; and a color image forming engine which receives the first and the second data from the image data controller and which is disposed in the color image forming apparatus.

### BRIEF DESCRIPTION OF THE DRAWINGS

The above and/or other aspects and advantages of the present invention will become more apparent by describing in detail preferred embodiments thereof with reference to the attached drawings in which:

FIG. 1 is a block diagram of a conventional color image forming apparatus and a host computer;

FIG. 2 is a block diagram of an image processing unit and an engine controller shown in FIG. 1;

FIG. 3 is a block diagram of a color image forming apparatus and a host computer according to an embodiment the present invention; and

FIG. 4 is a flowchart illustrating a color image forming method according to an embodiment the present invention.

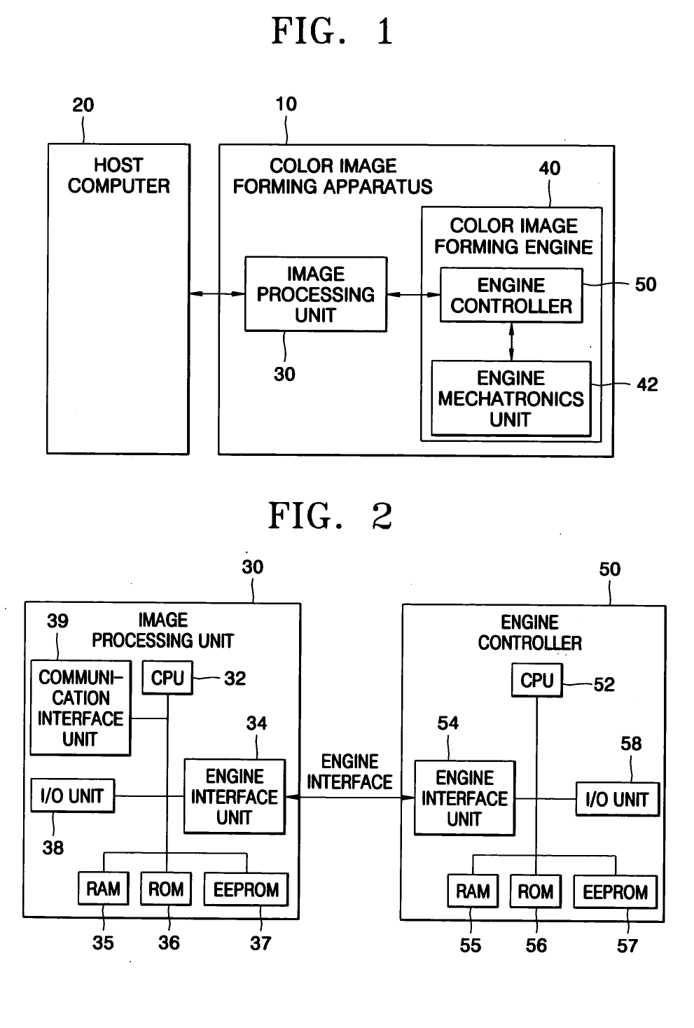

### DETAILED DESCRIPTION OF EMBODIMENT

Reference will now be made in detail to an embodiment of the present invention, an example of which is illustrated in the accompanying drawings, wherein like reference numerals refer to the like elements throughout. The embodiment is described below in order to explain the present invention by referring to the figures.

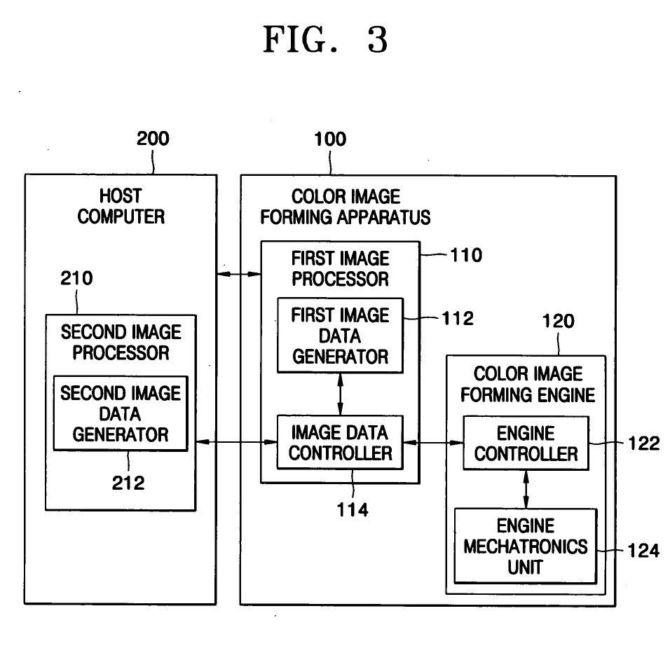

FIG. 3 is a block diagram of a color image forming apparatus and a host computer according to an embodiment of the present invention. Referring to FIG. 3, the color image forming apparatus 100 according to this embodiment of the present invention includes a first image processor 110 and a color image forming engine 120. The first image processor 110 includes a first image data generator 112 and an image data controller 114, and the color image forming engine 120 includes an engine controller 122 and an engine mechatronics unit 124.

A second image processor 210 is installed outside the color image forming apparatus 100 (i.e., remotely disposed). The second image processor 210 includes a second image data generator 212 which is, for example, placed into the host computer 200 in the form of a system expansion card. Alternatively, the second image processor 110 is, for example, externally attachable to the host computer 200 (not shown).

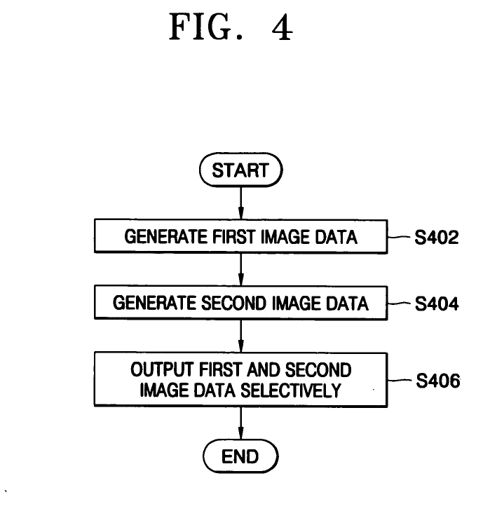

FIG. 4 is a flowchart showing a color image forming method according to this embodiment of the present invention. The following description makes concurrent reference to FIGS. 3 and 4. According to the color image forming method, in operation S402, first image data that has undergone image processing in the first image processor 110 is generated in a format suitable for use in the color image forming engine 120. Then, in operation S404, second image data image-processed in the second image processor 210 is generated into a format suitable for use in the color image forming engine 120. In operation S406, the image data controller 114 receives the first and second image data and selectively outputs them to the color image forming engine 120.

An apparatus and method for forming a color image according to this embodiment of the present invention will now be described with concurrent reference to FIGS. 3 and 4. The first image processor 110 is constructed using a low-priced circuit. The circuit is configurable to operate according to a graphic device interface (GDI) format. Since a GDI converts data into a data format suitable for printing graphic data under a Windows operating system of a host computer, the first image processor 110 is constructable using a relatively low speed circuit.

In contrast, the second image processor 210 is constructed using a high-priced circuit which may be designed to operate according to, by way of non-limiting example, a page description language (PDL) format. PDL is a program language that describes a physical image of a document for displaying the document on a screen or printing it on paper. Thus, the second image processor 210 is constructable using a higher-speed circuit with a video controller operating according to the PDL format.

A process for forming a color image at low price using the first image processor 110 will now be described. The host computer 200 transmits data for forming an image to the color image forming apparatus 100. The first image processor 110 within the color image forming apparatus 100 processes the data received from the host computer 200 into a format suitable for image forming. The image data processed by the first image processor 110 is transmitted to the image data controller 114. The image data is then transmitted to the engine controller 122 of the color image forming engine 120 according to the control of the image data controller 114. The engine controller 122 thereafter drives the engine mechatronics unit 124 to form a desired image.

A process for forming a color image at high price using the second image processor 210 will now be described. The host computer 200 transmits data intended for forming an image to its built-in second image processor 210, which in turn processes the data into a format suitable for image forming. The image data processed by the second image processor 210 is sent to the image data controller 114 through an image data interface (not shown). According to the control of the image data controller, the image data is then transmitted to the engine controller 122 of the color image forming engine 120, which drives the engine mechatronics unit 124 to form a desired image.

There are two modes for forming a color image in the color image forming engine 120: a single path mode in which four exposure units and four photoreceptor drums are used and a multi-path mode in which one exposure unit and one photoreceptor drum are used. Since the toner colors used for a color image forming apparatus are typically yellow (Y), cyan (C), magenta (M), and black (K), four developers with four color toner are needed.

The first and second image processors 110 and 210 are configured to support a single path mode or a multi-path mode.

When operating in a single path mode, charging a photoreceptor, exposing the photoreceptor to a laser beam, and developing image are performed in the order of YCMK colors. After these steps, the developed image is transferred to a transfer belt to create a color toner image. The color toner image is then transferred onto a sheet of paper and fused on the paper by heat and pressure to form a full color image.

When operating in a multi-path mode, charging a photoreceptor, exposing the photoreceptor to a laser beam, and developing an image and transferring the developed image are repeatedly performed for each color. The created color toner image is then transferred onto a sheet of paper and fused on the paper by heat and pressure to form a full color image.

Since the single path and multi-path modes are known in the art, a detailed description thereof will be omitted.

As described above, the color image forming apparatus 100 according to the present embodiment of the present invention can be implemented at low or high price. The color image forming apparatus 100 realized at low price is constructed to have the first image processor 110 with the GDI image data generator 112 and image data controller 114, engine controller 122, and engine mechatronics unit 124. On the other hand, the color image forming apparatus 100 realized at high price is constructed to have the second image processor 210 with the PDL image data generator 212, image data controller 114, engine controller 122, and engine mechatronics unit 124.

The image data controller 114 receives image data from the first and second image processors 110 and 210 and performs a control so as to selectively output them. For example, the image data controller 114 can operate so that the data from the second image processor 210 can be processed after completing processing of the data from the first image processor 110.

Although in the above embodiment, the first and second image processors 110 and 210 are constructed using low- and high-priced circuits, respectively, the opposite is also possible. If the second image processor 210 is constructed using a low-priced circuit, it can be upgraded to a high-priced circuit. This is possible because the second image processor 210 is located outside the color image forming apparatus 100. In some applications, it may be desirable to install the second image processor 210 into the host computer 200 as a system expansion card. This makes it easier to upgrade the second image processor.

As described above, this invention makes it possible to upgrade a color image forming apparatus when necessary. This is possible since the second image processor is housed within or installed outside the host computer. In particular, upgrading is much easier when the second image processor is placed into the host computer in the form of a system expansion card. Furthermore, since the color image forming apparatus of this invention has two or more image processors, it maximizes the use of the color image forming engine.

Although a few embodiments of the present invention have been shown and described, the present invention is not limited to these embodiments. Rather, it would be appreciated by those skilled in the art that changes may be made in this embodiment without departing from the principles and spirit of the invention, the scope of which is defined in the claims and their equivalents.

What is claimed is:

1. A color image forming method of a color image forming apparatus that is connected to a host computer and which receives image forming data generated in the host computer, comprising:
generating first image data image-processed into a format suitable for use in a color image forming engine by a first image processor disposed within the color image forming apparatus;
generating second image data image-processed into a format suitable for use in the color image forming engine by a second image processor disposed outside the color image forming apparatus; and
receiving at least one of the first and second image data and selectively outputting the at least one of the first and second image data to the color image forming engine via an image data controller disposed within the color image forming apparatus.

2. The method of claim 1, wherein the second image processor is a system expansion card which is insertable into the host computer.

3. The method of claim 1, wherein the second image processor is externally attached to the host computer.

4. The method of claim 1, wherein the first image processor is slower than the second image processor.

5. The method of claim 4, wherein the first image processor operates according to a graphic device interface (GDI) format.

6. The method of claim 4, wherein the second image processor operates according to a page description language (PDL) format.

7. The method of claim 6, wherein the second image processor has a video controller which operates according to the PDL format.

8. The method of claim 1, further comprising driving, via the color image forming engine, mechatronics to form the color image.

9. The method of claim 1, wherein the first image processor generates image data suitable for one of a single path mode and a multi-path mode of forming a color image.

10. The method of claim 1, wherein the second image processor generates image data suitable for one of a single path mode and a multi-path mode of forming a color image.

11. The method of claim 1, wherein the image data controller is located within the first image processor.

12. The method claim 2, wherein the second image processor is slower than the first image processor.

13. A color image forming apparatus connected to a host computer to receive image forming data generated in the host computer, comprising:
a first image data generator disposed within a first image processor disposed in the color image forming apparatus, which generates first image data image-processed into a format suitable for use in a color image forming engine;
a second image data generator disposed in a second image processor disposed outside of the color image forming apparatus, which generates second image data image-processed into a format suitable for use in the color image forming engine; and
an image data controller disposed within the color image forming apparatus and which receives at least one of the first and second image data and which selectively outputs the at least one of first and second image data to the color image forming engine.

14. The apparatus of claim 13, wherein the second image processor is a system expansion card which is insertable into the host computer.

15. The apparatus of claim 13, wherein the second image processor is externally attached to the host computer.

16. The apparatus of claim 13, wherein the first image processor is slower than the second image processor.

17. The apparatus of claim 16, wherein the first image processor operates according to a graphic device interface (GDI) format.

18. The apparatus of claim 16, wherein the second image processor operates according to a page description language (PDL) format.

19. The apparatus of claim 18, wherein the second image processor has a video controller which operates according to the PDL format.

20. The apparatus of claim 13, wherein the color image forming engine includes an engine controller which receives image data from the image data controller and which drives engine mechatronics to form the image.

21. The apparatus of claim 13, wherein the first image processor generates image data suitable for one of a single path mode and a multi-path mode of forming a color image.

22. The apparatus of claim 13, wherein the second image processor generates image data suitable for one of a single path mode forming a color image and a multi-path mode of forming the color image.

23. The apparatus of claim 13, wherein the image data controller is disposed within the first image processor.

24. The apparatus of claim 1, wherein the second image processor is externally attached to the image forming apparatus.

25. The apparatus of claim 13, wherein the second image processor is slower than the first image processor.

26. A color image forming system comprising:
a color image forming apparatus having therein a first data image generator which generates first image data;
a second image generator which generates second image data and is external to the color image forming apparatus;
an image data controller which receives the first and the second image data, selectively outputs the first and the second image data; and
a color image forming engine which receives the first and the second data from the image data controller and which is disposed in the color image forming apparatus.

27. The system of claim 26, further comprising a first image processor in which the first image data generator is disposed.

28. The system of claim 26, further comprising a first image processor in which the image data controller is disposed.

29. The system of claim 26, further comprising a second image processor in which the second image data generator is disposed.

30. The system of claim 29, further comprising a host computer in which the second image processor is disposed.

31. The system of claim 30, wherein the second image processor is a system expansion card insertable into the host computer.

32. The system of claim 26, further comprising an engine mechatronics unit, wherein the color image forming engine includes an engine controller which receives the first and the second image data and which controls the engine mechatronics unit to form an image.

33. The system of claim 26, wherein the first image processor is faster than the second image data processor.

34. The system of claim 26, wherein the second image processor is faster than the first image data processor.
